(19) United States
(12) Patent Application Publication
(10) Pub. No.: US 2012/0251665 A1
(43) Pub. Date: Oct. 4, 2012

(54) SYSTEM AND METHOD FOR PREPARING A SHELF-STABLE BOTANICAL EXTRACT

(75) Inventors: Kim Dorrell Larsen, Potomac, MD (US); Moise Augis, Guadeloupe (FR); Frederic Loret, Guadeloupe (FR)

(73) Assignee: KANASAO BV, Leiden (NL)

(21) Appl. No.: 13/437,993

(22) Filed: Apr. 3, 2012

Related U.S. Application Data
(60) Provisional application No. 61/471,261, filed on Apr. 4, 2011.

(51) Int. Cl. A23L 2/02; A23L 2/74; A23L 2/72; A23L 2/42; A23L 2/84

(52) U.S. Cl. 426/51; 426/489; 426/384; 426/61; 99/275

(57) ABSTRACT

A system and method for processing a plant material derived juice, comprising, substantially without a required pH modification, and substantially without a thermal antimicrobial process extracting a juice from plant material with a juice extractor, and filtering the juice through at least two tangential flow filter stages having a pore size of less than about 0.2 microns, to produce a substantially aseptic juice, which is substantially absent thermal decomposition products of sugars.

### FIELD OF THE INVENTION

The present invention relates to the field of processing of botanical extracts, and more particularly raw high soluble carbohydrate liquids.

### BACKGROUND OF THE INVENTION

It is known that various botanical pressings have a high soluble carbohydrate content, e.g., sucrose from sugar cane, and such pressings are valuable as foodstuffs. Because of the liquid nature and carbohydrate content, these pressings are fermentable, or otherwise subject to spoilage by microbial action. Traditionally, these botanical extracts are made storage stable initially by managing the pH level of the extract by adjusting it to a level <pH 4.6, and by adding generally chemical preservatives at a level, in a country-specific manner, that permits labeling as a preservative free composition. The extract is then heated to a pasteurization temperature, and subsequently aseptically packaged.

Raw cane juice contains a significant load of microorganisms, such as yeast, and after crushing, fermentation rate increases rapidly. Therefore, immediately processing can be important. Pasteurization of cane juice bearing high levels of yeast is difficult, since maintaining sufficient pasteurization conditions (time-temperature) to kill all organisms to achieve long shelf life, leads to carmelization, with change in taste and color.

U.S. Pat. No. 6,406,548, expressly incorporated herein by reference, discusses a sugar cane membrane filtration process. A process is disclosed for producing sugar from cane includes the step of filtering a sucrose-containing feed juice, which has been obtained from macerated sugar cane, through a first ultrafiltration membrane that has a first molecular weight cutoff. This ultrafiltration step produces a first ultrafiltration permeate and a first ultrafiltration retentate. The first ultrafiltration permeate is filtered through a second ultrafiltration membrane that has a second molecular weight cutoff that is lower than the first molecular weight cutoff. This second ultrafiltration step produces a second ultrafiltration permeate and a second ultrafiltration retentate. The second ultrafiltration permeate is nanofiltered through a nanofiltration membrane, thereby producing a nanofiltration permeate and a nanofiltration retentate. The nanofiltration retentate has a higher concentration of sucrose on a dry solids basis than the feed juice in step (a), and can be used in evaporation and crystallization operations to produce crystals of white sugar. The process can optionally include ion exchange and/or electrodialysis purification steps, prior to or after the nanofiltration step. See also, U.S. Pat. Nos. 3,799,806 and 4,627,880, expressly incorporated herein by reference.

In crossflow filtration, the feed is passed across the filter membrane (tangentially) at positive pressure relative to the permeate side. A proportion of the material which is smaller than the membrane pore size passes through the membrane as permeate or filtrate; everything else is retained on the feed side of the membrane as retentate. With cross-flow filtration, the flow rates are typically adjusted so that tangential motion of the bulk of the fluid across the membrane causes trapped particles on the filter surface to be hydrodynamically removed from the surface. This means that a cross-flow filter can operate continuously at relatively high solids loads without blinding. However, this also means that the pump is operating less efficiently (since a significant portion of the pumped fluid does not pass through the membrane), and the retentate contains a significant fraction of the desired material, i.e., a mix of particulates and solution, so that the process is not complete in a single pass. However, a higher overall liquid removal rate is achieved by the prevention of filter cake formation. The process feed remains in the form of a mobile slurry, suitable for further processing. Cross-flow filtration naturally leads to a sweeping of particles from the surface of the filter, and thus reduced caking and clogging. Crossflow filtration is different from dead-end filtration, also known as normal-flow filtration, in which the feed is passed through a membrane or bed, the solids being trapped in the filter and the filtrate being released at the other end. Because the filter is less subject to clogging, cross-flow filtration better lends itself to use in a continuous process, unlike batch-wise dead-end filtration. As compared to dead-end filtration, cross-flow filtration processes are typically designed to have a higher surface area filter and lower pressure differential operation.

Cross-flow filtration is typically selected for feeds containing a high proportion of small particle size solids (where the permeate is of most value) because solid material can quickly block (blind) the filter surface with dead-end filtration. Industrial examples of this include the extraction of soluble antibiotics from fermentation liquors. Cross flow membrane filtration technology has been used widely in industry globally. Filtration membranes can be polymeric or ceramic, depending upon the application. The principles of cross-flow filtration are used in reverse osmosis, nanofiltration, ultrafiltration and microfiltration.

Various methods may be used to unclog the membrane. In backwashing, the transmembrane pressure is periodically inverted by the use of a secondary pump, so that permeate flows back into the feed, lifting the fouling layer from the surface of the membrane. Clean-in-place (CIP) systems are typically used to remove fouling from membranes after extensive use. The CIP process may use detergents, reactive agents such as sodium hypochlorite and acids and alkalis such as citric acid and sodium hydroxide. A technically simpler approach than backwashing is to set the transmembrane pressure to zero by temporarily closing off the permeate outlet, which increases the attrition of the fouling layer without the need for a second pump. PFD is not as effective as backwashing in removing fouling, but can be advantageous.

See, e.g., Koros W J, Ma Y H, Shimidzu T (June 1996). “Terminology for membranes and membrane processes (IUPAC)”. Pure & Appl. Chem. 86 (7): 1479-1489; Bertera R, Steven H, Metcalfe M (June 1984). “Development Studies of crossflow filtration”. The Chemical Engineer 401: 10; van Reis, R.; Gadam, S.; Frautschy, L. N.; Orlando, S.; Goodrich, E. M.; Saksena, S.; Kuriyel, R.; Simpson, C. M.; Pearl, S.; Zydney, A. L. 1997. High Performance Tangential Flow Filtration. Biotech. Bioeng. 56:71-82; Zeman, L. J.; Zydney, A. L. 1996. Microfiltration and Ultrafiltration: Principles and Applications. Marcel Dekker, New York; www.fluxafiltri.com/eng/Products/S-02-00-Enology.pdf, each of which is expressly incorporated herein by reference.

### SUMMARY OF THE INVENTION

The present invention provides a system and method for rendering a raw, fermentable, vegetable or fruit extract storage stable without substantial heat treatment, by sequential filtering through filtration media, to substantially remove bacteria, leading to a storage stable botanical extract suitable for human consumption. The method prepares a storage stable botanical extract by extracting at least one plant to obtain a liquid having a high soluble carbohydrate content, sequentially filtering the extract until bacterial activity is substantially absent, and preferably storing packaging the filtered liquid under aseptic conditions to avoid re-contamination.

A preferred extract is cane juice, which may be prepared in a traditional manner, or in an optimized process. For example, a sucrose-containing feed juice may be manufactured by macerating sugar cane or pieces thereof, thereby producing a macerated material that comprises pulp and liquid, and then separating the liquid in the macerated material from the pulp, for example by one or more of centrifugation, conventional filtration, or screening. In one particular embodiment, the cane is macerated by first passing it through a hammer mill, and optionally it can subsequently be passed through a grinder, whereby the cane is converted into a mixture of pulp and sucrose-containing liquid.

After separation of the fibrous pulp from the liquid, and before the first filtration, the process can optionally include an additional step or steps to remove residual cane and silt from the separated liquid (juice). This can be done by screening and/or filtration.

The raw juice is typically contaminated with bacteria and/or yeast. The load of microbial contamination is typically high enough that Pasteurization as a means for sterilization leads to significant changes in flavor and color, and in fact a room temperature storage stable product may not be possible. Thus, for example, milk is a product that is difficult to decontaminate, though an ultrapasturization treatment is now available; however, this high temperature, short time process leads to more significant flavor and color changes than a traditional lower temperature, longer time process.

According to a preferred embodiment, a sufficient amount of a low level of heat treatment is applied to deactivate enzymes in the liquid, e.g., oxidases and/or peroxidases (e.g., polyphenoloxidase, peroxidase). See, Carolyn S. Bucheli, Simon P. Robinson, “Contribution of Enzymic Browning to Color in Sugarcane Juice”, J. Agric. Food Chem., 1994, 42 (2), pp 257-261; James C. P. Chen, Chung-Chi Chou, “Chen-Chou cane sugar handbook: a manual for cane sugar manufacturers and their Chemists”, John Wiley & Sons (1993); G. Eggleston, “Deterioration of cane juice—sources and indicators”, Food Chemistry 78 (2002) 95-103; Hesham A. Eissa, A. Nadir Shehata, Mostafa T. Ramadan and Hatem S. Ali, “Preservation of Sugarcane Juice by Canning 1. Effect of Thermal and Chemical Pre-treatments on the Enzymatic Browning of Sugarcane Juice”, Journal of American Science 2010; 6(9); Weerachet Jittanit, Somsak Wiriyaputtipong, Hathainid Charoenpornworanam, and Sirichai Songsermpong, “Effects of Varieties, Heat Pretreatment and UHT Conditions on the Sugarcane Juice Quality”, Chiang Mai J. Sci. 2011; 38(1): 116-125 (2010), www.science.cmu.ac.th/journal-science/josci.html, expressly incorporated herein by reference. The treatment need not be (and generally is not) sufficient to sterilize the liquid, and preferably is sufficiently low to avoid carmelization of the sugars.

The filtered extract may be further processed to form a beverage, such as lemonade, cane juice beverage, carbonated beverage (e.g., soda), fermented beverage, brewed tea, brewed coffee, without the need for a pasteurization process including the filtered extract. The process preferably does not involve any pH regulation, nor addition of any preservative or stabilizer, before and after processing. Thus, the natural flavor of the vegetable product, e.g., cane, is preserved in the final product.

The process preferably comprises two successive stages of filtration, using the same filter, with a modestly sized retention vessel between the stages. Each of these successive filtration steps is preferably a tangential filtration step with filtering membrane with an average pore diameter ranging from 0.05 to 0.14 μm. The multi-stage filtration enables achieving effective sterilization while assuring a high productivity yield within an efficient industrial environment.

It is noted that the second stage of filtration is relatively efficient, since only a small amount of particulates retained by the filter remain in the solution. Therefore, the second stage polishes the solution to eliminate residual contamination, to ensure long shelf life. The first stage filtration removes most of the contamination, and thus clogs the filter at a higher rate, and the filter cleaning step is required more often. An efficient mode of operation is therefore to clean the filter between the first and second stage filtering, with a subsequent first stage following the second stage without an intervening cleaning step.

A plant which performs the method, for example for processing sugar cane, produces an aseptic transparent cane juice that has similar organoleptic characteristics to the cane juice that results from the single press of the sugar cane without further treatment. This juice has a high enough level of sugar that permits use as a sweetener, for example of carbonated beverages. For example, a sucrose concentration in excess of 85 mg/ml, and preferably in excess of 100 mg/ml. In addition, raw filtered cane juice has a distinct and enjoyable flavor, and thus the resulting beverage need not include an additional flavoring, but which may include a complementary flavoring.

Of course, other juices may be similarly processed.

The process is preferably “in-line”, meaning that the process proceeds substantially without bulk storage of intermediate products for significant periods. Preferably, the process also processes raw cane as it is filtered without delay. The storage vessel which receives the liquid subsequent to the second stage is preferably sterile, and for example may be steam sterilized. The same storage vessel may be used for the filtrate from the first stage, though this need not be sterile, only substantially clean, since the liquid will be filtered again.

Because the product of the sequence of filtration is generally sterile, it can be used immediately in subsequent processes, or packaged, stored and/or shipped for later use.

According to one embodiment, a fermented cane juice product is prepared, which retains the raw cane juice flavor, and can then be inoculated with a desired fermenting organism. The fermented beverage may be consumed as prepared, or distilled to a higher alcohol content. As known in the brewing arts, additional flavorants may be employed, and natural products used to control or influence the fermentation. For example, fermentation can be stopped using hops.

An alternate product provides a concentrated filtered cane juice. The product may be concentrated by vacuum dehydration, osmotic membrane concentration, or other technology. Preferably, no heat treatment is employed, except perhaps to the extent used to denature enzymes in the juice. pH modifiers are preferably not employed.

The filtered product may be packaged in aseptic packaging that maintains the product, without refrigeration, with a shelf life of 12 months.

The filtered juice may also be used to sweeten confections and dairy products, such as in ice cream (with milk), sorbet (without milk), yogurt, candy, baked goods (e.g., biscuits), chocolate, sauces, etc. When the juice is used in this manner, it may not be necessary to package it, and the end product may be produced in a facility collocated with the juice filtration system.

The filtered juice may further be used in baked goods, such as cake, breads, biscuits, pies, muffins, and the like. In such cases, the juice may be used remotely from the site of production, stored in a sterile container.

The filtered product is preferably sufficiently sweet, that it can be diluted in use and remain sweet to the taste.

It is therefore an object to provide method for obtaining a natural filtered vegetable or fruit juice extract, which is used to sweeten a beverage such as brewed coffee, or brewed tea, with improved properties, and particularly having a storage stability of at least eight months, good organoleptic characteristics, with conservation of key minerals and vitamins, wherein the filtered extract is produced by a process comprising a multi-stage filtration of at least two successive tangential filtration steps of a raw extract of non-heated and non-treated vegetables derived from a single step dry pressing operation, wherein the tangential filtration steps are performed with a filtration membrane having an average pore diameter ranging from 0.05 to 0.14 μm.

The filtered material may also be a vegetable or fruit juice, or a liquid ingredient like brewed coffee, brewed tea. The liquid may be a combination as well.

The filtration process removes microbial contaminants, while preserving flavors and nutritional components.

An intermediate ultra-clean or aseptic storage tank maybe be placed between the two successive filtration steps. The filters may comprise an inorganic filtering membrane or a ceramic membrane.

Preferably, the raw juice is extracted with a one-step pressing and without the need of or use of heat treatment, of the vegetables before or after pressing. Likewise, pH modification, e.g., acidification, is preferable not required and not used.

The product of the processing is preferably storage stable to room temperature, without need to be pasteurized. However a pasteurization step can be added before or after the multi-stage sterilizing filtration. As noted above, a Pasteurization process operating on substantially contaminated fluid may fail to achieve sterility. Performing such a process after filtration permits use of modest processing parameters.

The extracted raw juice may be heat treated for enzyme inhibition before or after last step of micro-filtration. Addition of enzyme inhibitors may also be employed.

The filtered juice may be directly aseptically packaged after the last step of micro-filtration with or without the use of an aseptic tank in the packaging architecture.

According to an aspect of the present technology, there is provided a method for producing a concentrate from a frozen juice. The process comprises the steps of: obtained, by pressing at least one vegetable (without any heat process of the vegetable, without the need of any regulation of the pH of the extracted juice and without the need of any pasteurization of the extracted juice from the vegetables), and then microfiltration with a multi-stage filtration using at least two successive tangential filtration steps each with a filtration membrane having an average pore diameter ranging from about 0.05 to 0.14 μm; aseptically freezing the obtained juice; slowly defrosting the processed juice in order to recover the lower melting temperature components of the frozen juice, to provide a first level of concentrate; and optionally, vacuum evaporating the first level of concentrate.

According to another aspect of the present technology, a method is provided for preparing alcoholic drinks from a sterile vegetable juice, which may include cane juice, comprising pressing at least one vegetable, without any heat processing of the vegetable, without the need of any regulation of the pH of the extracted juice, and without the need of pasteurization of the pressed at least one vegetable, microfiltering or ultrafiltering using at least two successive tangential filtration steps each employing a filtration membrane having an average pore diameter ranging from 0.05 to 0.14 μm, to produce a sterile juice, and subsequently fermenting the sterile juice isolated from unintentional bacterial contamination, with an added culture, e.g., yeast. This aspect provides unique alcoholic drinks having very pleasant organoleptic properties derived mainly from the fermented uncooked vegetable juice, e.g., cane juice. The fermenting organism may be removed or stopped, for example, by a subsequent microfiltration or ultrafiltration step or steps.

The alcoholic fermentation with yeast may be conducted between 20° C. and 28° C. in a sterile air or in a carbonic acid gas atmosphere, in a sterilized tank. The fermentation may be conducted until a concentration between 2% and 14% of ethanol is obtained. The fermentation may be ended by elimination of yeast by micro-filtration with a ceramic membrane, having membrane pores of about 0.05 μm to 0.14 μm.

Botanical juices may be prefiltered to remove bulk particulates, before microfiltration. This prefiltration may be, for example, with a relatively large pore size, e.g., 10 μm.

See, 20120060832, 20050229813, 20020162550, 20020011246, 20010001178, U.S. Pat. Nos. 7,338,562, 6,709,527, 5,281,279, 5,554,227, 5,902,409, 6,096,136, 6,406,548, 6,479,636, 6,355,110, 6,245,153, 6,228,178, 6,174,378, 6,156,563, 6,096,136, 6,068,869, 5,554,227, 5,468,301, 5,454,952, 5,281,279, 4,784,859, 4,332,622, 4,115,147, 4,083,732, 4,039,348, 3,994,743, each of which is expressly incorporated herein by reference.

### BRIEF DESCRIPTION OF THE DRAWINGS

FIG. 1 shows a schematic diagram of the system according to the invention;

FIG. 2 shows a process flow diagram of a first embodiment;

FIG. 3 shows a process flow diagram of a second embodiment;

FIG. 4 shows a process flow diagram of a third embodiment;

FIG. 5 shows a process flow diagram of a fourth embodiment;

FIG. 6 shows a process flow diagram of a freeze concentration method;

FIG. 7 shows a process flow diagram of a fermentation method;

FIG. 8 shows a schematic diagram of a juice concentrator embodiment.

### DETAILED DESCRIPTION OF THE PREFERRED EMBODIMENTS

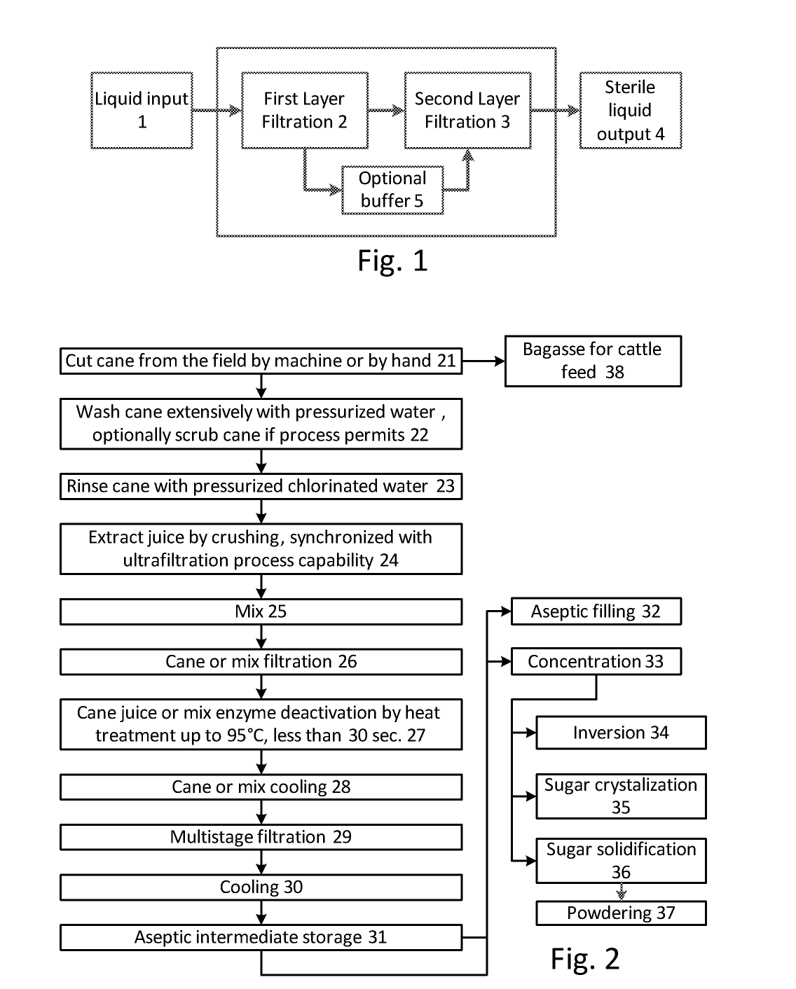

FIG. 1 shows a process flow diagram including a two stage filtration process for purifying a botanical liquid. The botanical liquid is obtained by pressing or shredding, yielding a relatively contaminated crude liquid. The juice may be prefiltered to remove large pieces, fibers, pulp, etc. The juice liquid input 1 is fed to a first filter 2, which is a 0.05-0.14 μm pore cross flow filter. The filtrate is then fed directly to a second stage filter 3, which is also a 0.05-0.14 μm pore cross flow filter, or held in an intermediate storage tank 5 and then passed to the second stage filter 3, before exiting the process as a sterile liquid output 4. The double-filtered filtrate is reasonable sterile, and is storage stable at room temperature, e.g., for over six months.

The process outlined does not require heat treatment to achieve storage stability, though a small amount of heat treatment may be employed to deactivate enzymes in the juice that might degrade the product over time. The process outlined also does not require pH regulation to achieve product stability.

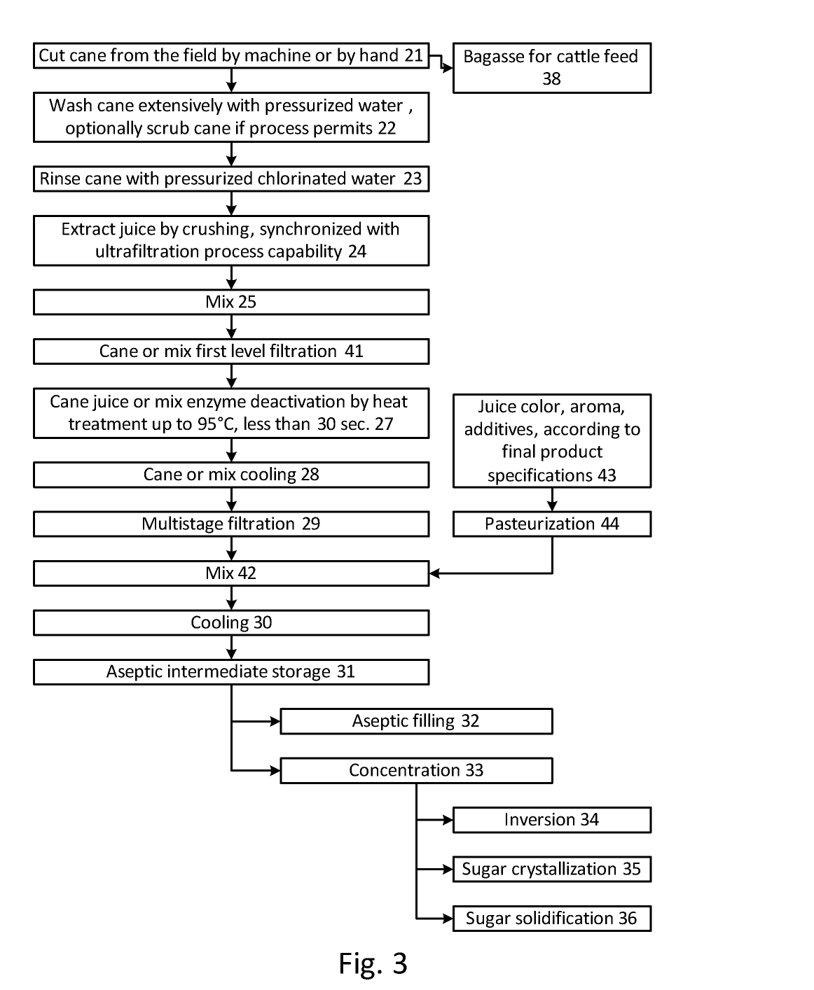

FIGS. 2 and 3 show a more detailed process flow diagram for sugar cane processing. Initially, sugar cane is cut from the field, by hand or machine 21. The cane is then extensively washed with pressurized water 22, and optionally scrubbed, conditions permitting. The cane is then rinsed with pressurized chlorinated water 23. The cleaned cane is then crushed 24, and the cane juice extracted. The juice extraction is synchronized with the downstream processing, so there is no large accumulation of juice at this stage. The remaining cane solids may be used as bagass for cattle feed 38 or used in the production of biofuel.

According to the process shown in FIG. 2, the cane juice may be mixed 25 with other components at this stage, such as other juice, flavor, aroma, additives, provided according to the final product requirements.

The juice or mix may be filtered 26. The cane juice or cane juice mix is then heated above about 90 C, e.g., to about 95 C for less than 30 seconds 27, to deactivate enzymes (e.g., oxidases, peroxidases) present. The heated juice is then cooled 28. The cooled juice is then subjected to multiple stages of ultrafiltration 29, for example using filters having a pore size of less than about 0.14 micron pore size. The multiple stages of ultrafiltration are synchronized, so there is no large accumulation of juice. A minimum of two stages of filtration are employed, seeking to effectively sterilize the juice, and stabilize the product against microbial spoilage during room temperature storage in aseptic packaging, in excess of 3 months, preferable six months, and more preferably eight months.

According to the process shown in FIG. 3, the filtered septic cane juice may then be mixed with other components 42, which should also be Pasteurized or aseptic. The components may be, for example, other juice, flavor, aroma, additives, provided according to the final product requirements.

The product is cooled after filtering 30, and stored in aseptic intermediate storage 31, from which it can be packaged in aseptic packaging 32, or, for example, concentrated using a low heat process 33, such as freeze fractionation. According to the process shown in FIG. 2, the aseptic concentrated juice may be inverted 34, converted to crystal sugar 35, solidified sugar 36, or powdered sugar 37.

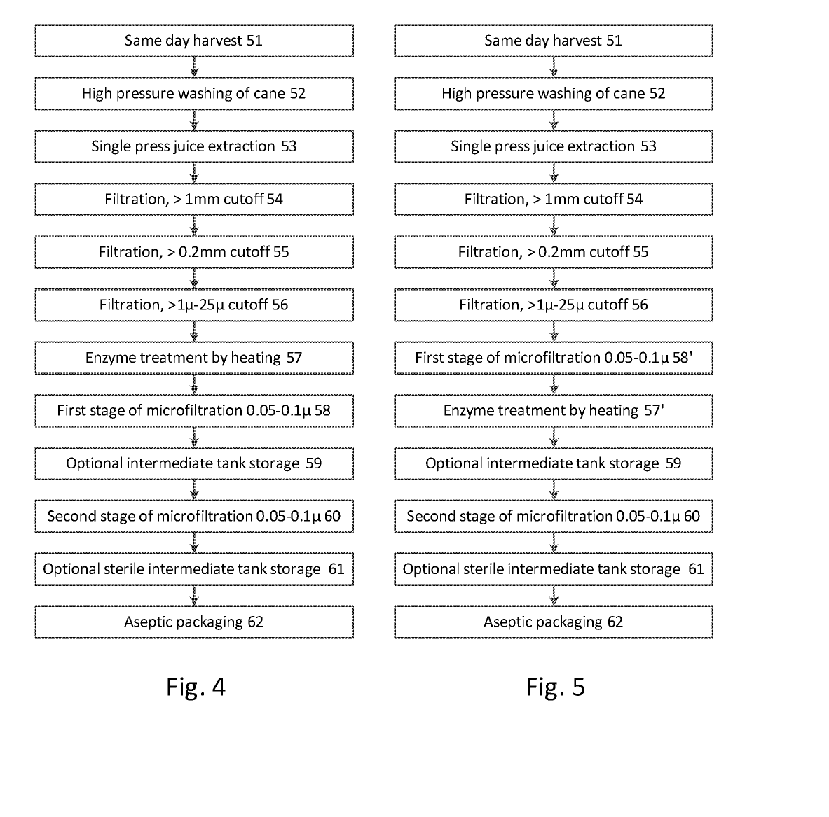

FIG. 4 shows a process for producing aseptic cane juice. The cane is harvested, and the same day, processed 51. A high pressure washing system is used to clean the harvested cane 52. The rinsed can may then be washed with pressurized chlorinated water. Other traditional processing steps may be used, as well. The juice from the cleaned cane is then extracted in a single pass, such as with a crusher 53. The juice may be mixed with other components. A series of filtration steps is then used to remove particulates. A first filter may be used to remove particles over one millimeter in diameter 54. A second stage of filtration then removes particles over 0.2 millimeters (200 microns) 55. A third stage of filtration is employed to remove particles over between 1 to 25 microns 56.

The pre-filtered juice is then heated to deactivate enzymes 57. For example, a heating to 95 C for less than 30 seconds, followed by cooling, for example in a cool water jacket, is typically sufficient. Alternately, the enzyme deactivation may be conducted before the third stage of filtration, or after the first or second stage of ultrafiltration, at other stages of the process.

The juice is then subjected to a first stage of ultrafiltration 58 using a cross flow filter having a pore size of 0.05-0.1 micron. Optionally, after the first stage of ultrafiltration, the juice may be stored in an intermediate storage tank 59. The juice is then subjected to a second stage of ultrafiltration 60 using a cross flow filter having a pore size of 0.05-0.1 micron. Optionally, after the second stage of ultrafiltration, the juice may be stored in an intermediate storage tank 61. The two intermediate storage tanks may be separate, to avoid cross contamination, and provide higher productivity. The second intermediate storage tank should be aseptic.

The aseptic juice may be mixed with other components, e.g., juice color, aroma, additives, according to final product specifications, which is pasteurized or otherwise sterilized.

The (at least) twice ultrafiltered juice is then cooled, stored in an aseptic tank, and aseptically packaged 62, or otherwise processed, such as by concentration. The concentrated cane juice can be inverted, crystallized or solidified.

FIG. 5 shows an alternate process to that shown in FIG. 4. The cane is harvested, and the same day, processed 51. A high pressure washing system is used to clean the harvested cane 52. Other traditional processing steps may be used, as well. The juice from the cleaned cane is then extracted in a single pass, such as with a crusher 53. A series of filtration steps is then used to remove particulates. A first filter may be used to remove particles over one millimeter in diameter 54. A second stage of filtration then removes particles over 0.2 millimeters (200 microns) 55. A third stage of filtration is employed to remove particles over between 1 to 25 microns 56.

The juice is then subjected to a first stage of ultrafiltration using a cross flow filter having a pore size of 0.1-0.2 micron 58′. The pre-filtered juice is then heated to deactivate enzymes 57′. For example, a heating to 95 C for less than 30 seconds, followed by cooling, for example in a cool water jacket, is typically sufficient.

Optionally, after the first stage of ultrafiltration, the juice may be stored in an intermediate storage tank 59. The juice is then subjected to a second stage of ultrafiltration 60 using a cross flow filter having a pore size of 0.05-0.1 micron. Optionally, after the second stage of ultrafiltration, the juice may be stored in an intermediate storage tank 61. The two intermediate storage tanks may be separate, to avoid cross contamination, and provide higher productivity. The second intermediate storage tank should be aseptic. The (at least) twice ultrafiltered juice is then aseptically packaged 62, or otherwise processed.

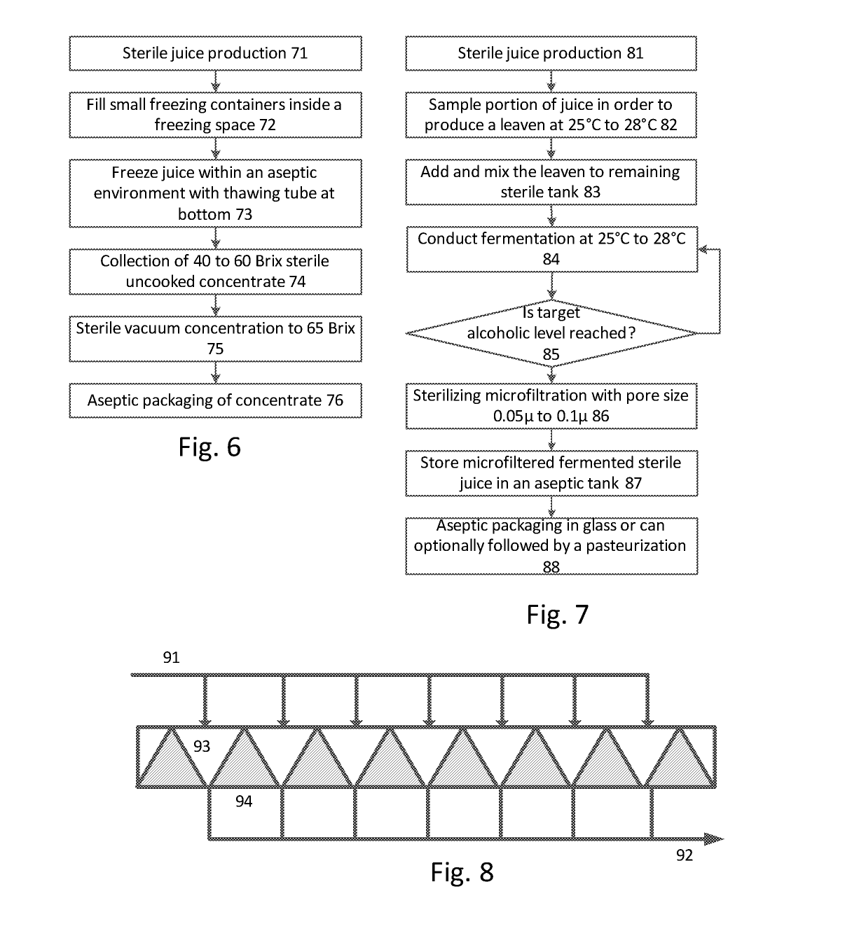

FIG. 6 shows a process for concentrating the cane juice using a freeze-fractionation process. See, e.g., Abbas Fadhl Mubarek Al-Karkhi, Lo Wan Mei, Teresa Chua Li San and Azhar Mal Easa, “Evaluation Of Freeze-Concentrated Sugar-Cane Juice”, http://eprints.usm.my/8132/1/Evaluation_of_Freeze-Concentrated_Sugar-Cane_Juice_(PPTIndu).pdf; Sirichai Songsermpong and Weerachet Jittanit, “Comparison Of Peeling, Squeezing And Concentration Methods For The Sugarcane Juice Production”, Suranaree J. Sci. Technol. 17(1):49-55 (2010), http://sutlib2.sut.ac.th/Sutjournal/Files/H132530f.pdf; Abhishek B. Sahasrabudhe, Ranjit R. Desai, Siddharth K. Jabade, “Modeling and Simulation of a Freeze Concentration Technique for Sugarcane Juice Concentration”, Applied Mechanics and Materials (Volumes 110-116), pp. 2768-2773 (2011), 10.4028/www.scientific.net/AMM. 110-116.2768; Milind V. Rane, and Siddharth K. Jabade, “Freeze concentration of sugarcane juice in a jaggery making process”, Applied Thermal Engineering 25 (14-15): 2122-2137 (2005); J. Sánchez, Y. Ruiz, J. M. Auleda, E. Hernández, M. Raventós, “Freeze Concentration in the Fruit Juices Industry”, Food Science and Technology International August 2009 vol. 15 no. 4 303-315; E. Hernándeza, M. Raventósa, J. M. Auledaa, A. Ibarzb, “Concentration of apple and pear juices in a multi-plate freeze concentrator”, Innovative Food Science & Emerging Technologies, Volume 10, Issue 3, July 2009, Pages 348-355, each of which is expressly incorporated herein by reference.

As shown in FIGS. 6 and 8, The aseptic juice 71 is received 91, and partially frozen by contact with cold metal surfaces, which may be conical structures 94, as shown in FIG. 8, or chilled metal plates. The cane juice fills small containers 93 within a freezing space 72, 92, with a thawing tube at the bottom. The first parts of the solution to freeze 73 has a lower sugar content than the residual, so by removing ice crystals, the sugar content increases, until a syrup is formed. Since this process does not require heating, the natural flavor of the cane juice is retained. The crystals tend to stick to the surfaces, and therefore after a mass of ice forms on the surface, the remaining syrup is removed 92, and the ice melted by intermittent activation of the thawing tube. The resulting freeze concentrate, which starts at about 10 Brix, is concentrated to 40-50 Brix 74 in an aseptic environment. The concentrated cane juice may then be further concentrated by vacuum concentration to about 65 Brix 75, and then aseptically packaged 76 or used in a food process.

FIG. 7 shows a process for producing an alcoholic beverage from cane juice. In a fermentation process, it is important to ensure an appropriate cultivar of fermentative organisms. Therefore, the fermentable material should be aseptic, and then a culture of fermentation organism, e.g., yeast, added. As shown, the aseptic ultrafiltered cane juice 81 is stored in an aseptic storage tank. A portion of the juice is sampled 82, and stored at 25° C. to 28° C., in non-aseptic conditions. That is, the sample becomes contaminated, and is permitted to ferment. Of course, a standard yeast may also be added, but it is preferred to select for a vigorous strain contemporaneously. After the sample has begun to ferment, and the properties of the fermented sample approved, the leavened sample may then be added to the aseptic bulk 83. The bulk fermentation is preferably also conducted at 25° C. to 28° C. 84. Of course, fermentation at other temperatures may also be conducted. The fermentation is conducted until a desired alcohol concentration is reached 85. Typically, the fermentation is not conducted to completion, so that the resulting product remains sweet. The alcoholic fermentation product is then sterilized by ultrafiltration through a cross flow filer having a pore size of about 0.05-0.1 microns 86, to remove the fermenting organisms. The filtrate is then stored in a sterile tank 87, and packaged aseptically in cans or glass 88. A Pasteurization step may then follow packaging, to provide a longer shelf life.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method for processing a plant material derived juice, comprising, substantially without a required pH modification, and substantially without a thermal antimicrobial process:
extracting a juice from plant material;
filtering the juice through at least two tangential flow filter stages having a pore size of less than about 0.2 microns, to produce a substantially aseptic juice, which is substantially absent thermal decomposition products of sugars.

2. The method according to claim 1, wherein the at least two tangential flow filter stages having a pore size of between about 0.05 and 0.14 microns.

3. The method according to claim 2, wherein the at least two tangential flow filter stages have a same pore size.

4. The method according to claim 1, wherein the plant material is sugar cane.

5. The method according to claim 1, further comprising freeze concentrating the filtered juice.

6. The method according to claim 1, further comprising fermenting the filtered juice, substantially without Pasteurizing the juice prior to fermentation.

7. The method according to claim 1, further comprising deactivating at least one enzyme in the juice, substantially without generating the thermal decomposition products of sugars.

8. The method according to claim 1, wherein the juice extracted from the plant material is contaminated with microbes, and the filtered juice is substantially unfermented.

9. A system for processing a plant material derived juice, comprising:
a plant material juice extractor; and
a filtration system comprising at least two tangential flow filter stages having a pore size of less than about 0.2 microns, configured to produce a substantially aseptic juice,
wherein the aseptic juice is produced substantially without a required pH modification, and substantially without a thermal antimicrobial process or production of thermal decomposition products of sugars.

10. The system according to claim 9, wherein the at least two tangential flow filter stages having a pore size of between about 0.05 and 0.14 microns.

11. The system according to claim 9, wherein the at least two tangential flow filter stages have a same pore size.

12. The system according to claim 9, wherein the filtration system comprises ceramic membranes.

13. The system according to claim 9, wherein the plant material is sugar cane.

14. The system according to claim 9, further comprising a freeze concentration system configured to increase a sugar concentration of the filtered juice.

15. The system according to claim 9, further comprising a fermentation tank, configured to ferment the filtered juice, substantially without Pasteurizing the juice prior to fermentation.

16. The system according to claim 9, further comprising a heater and cooler, configured to deactivate at least one enzyme in the juice, substantially without generating the thermal decomposition products of sugars.

17. The system according to claim 9, further comprising am aseptic packaging system configured to package the aseptic juice.

18. A method for processing sugar cane, comprising:
crushing the sugar cane to extract cane juice;
substantially without delay, and substantially without modifying a pH of the cane juice, and substantially without pasteurizing the cane juice, filtering the juice through at least two tangential flow filter stages having a pore size of between about 0.05 and 0.14 microns, to produce a substantially aseptic cane juice, which is substantially absent thermal decomposition products of sugars, and which retains substantial organoleptic properties of raw cane juice.

19. The method according to claim 18, further comprising deactivating at least one oxidase or peroxidase enzyme in the juice, substantially without generating the thermal decomposition products of sugars.

20. The method according to claim 18, further comprising prefiltering the extracted cane juice to remove particulates, and heating the cane juice to over 90 C for about 30 seconds to deactivate degradative enzymes in the cane juice, substantially without generating thermal decomposition products of sugars.
